(19) United States
(12) Patent Application Publication
(10) Pub. No.: US 2006/0265253 A1
(43) Pub. Date: Nov. 23, 2006

(54) Patient data mining improvements

(76) Inventors: R. Bharat Rao, Berwyn, PA (US); Sriram Krishnan, Exton, PA (US); William A. Landi, Devon, PA (US); Randall Case, Blue Bell, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/435,660

(22) Filed: May 17, 2006

Related U.S. Application Data
(60) Provisional application No. 60/682,113, filed on May 18, 2005.

(51) Int. Cl. G06F 19/00; G06F 17/30

(52) U.S. Cl. 705/3; 707/3

(57) ABSTRACT

Improvements in mining information from patient records and/or use of such mined information are provided. A scheduled appointment is identified. In response, the patient record is mined to identify any possible lack of adherence. A form requiring authorization and including a clinical action or prescription is generated to address, at least in part, the lack of adherence. Contact with a patient is initiated by a processor, at least in part, in response to a lack of adherence. A request for documentation is generated in response to mining indicating an inadequate probability of adherence to a guideline. During real-time, additional information to be obtained which may alter a probability is suggested.

### RELATED APPLICATIONS

The present patent document claims the benefit of the filing date under 35 U.S.C. §119(e) of Provisional U.S. Patent Application Ser. No. 60/682,113, filed May 18, 2005, which is hereby incorporated by reference.

### FIELD

The present embodiments relate to data mining, and more particularly, to systems and methods for mining and/or using clinical information from patient medical records.

### BACKGROUND

In general, data mining is a process to determine useful patterns or relationships in data stored in a data repository. Typically, data mining involves analyzing large quantities of information to discover trends in the data.

Health care providers accumulate vast stores of clinical information. Clinical information maintained by health care organizations is usually unstructured. Therefore, it is difficult to mine using conventional methods. Moreover, since clinical information is collected to treat patients, as opposed, for example, for use in clinical trials, the information may contain missing, incorrect, and inconsistent data. Often key outcomes and variables are simply not recorded.

While many health care providers maintain billing information in a relatively structured format, this type of information is limited by insurance company requirements. That is, billing information generally only captures information needed to process medical claims, and more importantly reflects the “billing view” of the patient, i.e., coding the bill for maximum reimbursement. As a result, billing information often contains inaccurate and missing data, from a clinical point of view. Furthermore, billing codes may be incorrect.

Some systems create medical records pursuant to a predetermined structure. The health care provider interacts with the system to input patient information. The patient information is stored in a structured database. However, some physicians may prefer to include unstructured data in the patient record, or unstructured data may have been previously used for a patient.

Mining clinical information may lead to insights that otherwise may be difficult or impossible to obtain. It would be desirable and advantageous to provide techniques for mining and using clinical information.

### SUMMARY

In various embodiments, systems, methods and computer readable media are provided for improving mining information from patient records and/or use of such clinical information. The mining may be used to initiate a workflow or a workflow is used to initiate the mining.

In a first aspect, a scheduled appointment is identified by a processor. In response, the patient record is mined to identify any possible lack of adherence. If there is a lack of adherence, notice is provided so that the lack of adherence may be addressed at the appointment. In a second aspect, a lack of adherence is determined based on mining a patient record. A form requiring authorization and including a clinical action or prescription is generated to address, at least in part, the lack of adherence. In a third aspect, contact with a patient is initiated by a processor, at least in part, in response to a lack of adherence. In a fourth aspect, a request for documentation is generated in response to mining indicating an inadequate probability of adherence to a guideline. Any one or combinations of two or more of these workflows may be used. These workflows increase the likelihood of adherence to a clinical guideline, possibly improving the treatment of patients.

In a fifth aspect, the mining may be used for real-time alerts during care. For example, a probability of a disease is determined as a function of mining a previous patient record and data input at the time of treatment. Additional information to be obtained which may alter the probability is suggested by the processor so that additional information may be received at the time of treatment.

Any one or more of the aspects described above may be used alone or in combination. These and other aspects, features and advantages will become apparent from the following detailed description of preferred embodiments, which is to be read in connection with the accompanying drawings. The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

FIG. 1 is a block diagram of one embodiment of a computer processing system for mining patient data and/or using resulting mined data;

FIG. 2 shows an exemplary computerized patient record (CPR);

FIG. 3 shows an exemplary data mining framework for mining clinical information;

FIG. 4 shows an exemplary statistical summary;

FIG. 5 shows a graph of data supporting a portion of the statistical summary of FIG. 4;

FIG. 6 shows a visual representation of a relationship between a patient state, a patient record, and a diagnostic related grouping output;

FIG. 7 shows one embodiment of workflows associated with patient data mining;

FIG. 8 shows linking patient records in one embodiment.

### DESCRIPTION OF PREFERRED EMBODIMENTS

The present embodiments provide improvements in patient data mining. U.S. Published Application No. 2003/0120458 discloses mining unstructured and structured information to extract structured clinical data. Missing, inconsistent or possibly incorrect information is dealt with through assignment of probability or inference. These mining techniques are used for quality adherence (U.S. Published Application No. 2003/0125985), compliance (U.S. Published Application No. 2003/0125984), clinical trial qualification (U.S. Published Application No. 2003/0130871), and billing (U.S. Published Application No. 2004/0172297). The disclosures of the published applications referenced in the above paragraph are incorporated herein by reference. Other patent data mining for mining approaches may be used, such as mining from only structured information, mining without assignment of probability, or mining without inferring for inconsistent, missing or incorrect information.

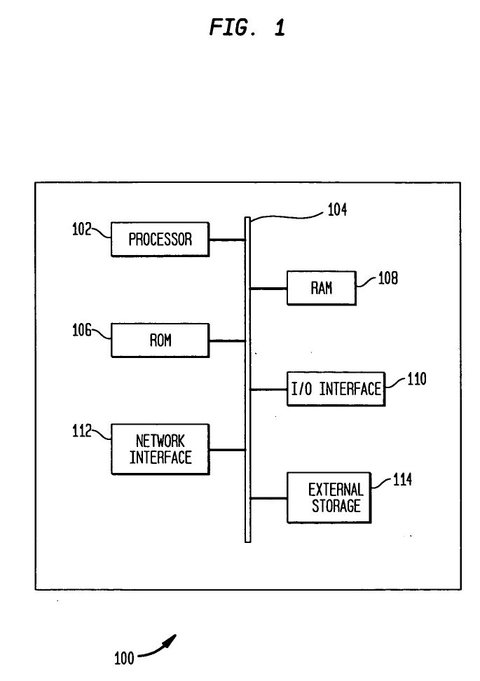

FIG. 1 is a block diagram of an example computer processing system 100 for implementing the embodiments described herein, such as assisting with adherence to a clinical guideline. The systems, methods and/or computer readable media may be implemented in various forms of hardware, software, firmware, special purpose processors, or a combination thereof. Some embodiments are implemented in software as a program tangibly embodied on a program storage device. By implementing with a system or program, completely or semi-automated workflows and/or data mining are provided to assist a person or medical professional.

The system 100 is a computer, personal computer, server, PACs workstation, imaging system, medical system, network processor, or other now know or later developed processing system. The system 100 includes at least one processor (hereinafter processor) 102 operatively coupled to other components via a system bus 104. The program may be uploaded to, and executed by, a processor 102 comprising any suitable architecture. Likewise, processing strategies may include multiprocessing, multitasking, parallel processing and the like. The processor 102 is implemented on a computer platform having hardware such as one or more central processing units (CPU), a random access memory (RAM), and input/output (I/O) interface(s). The computer platform also includes an operating system and microinstruction code. The various processes and functions described herein may be either part of the microinstruction code or part of the program (or combination thereof) which is executed via the operating system. Alternatively, the processor 102 is one or more processors in a network and/or on an imaging system.

The processor 102 performs the workflows, data mining and/or other processes described herein. For example, the processor 102 is operable to identify an appointment for a patient scheduled to occur in the future. The appointment triggers the processor 102 to mine relevant medical records, such as to determine a probability of lack of adherence of patient treatment to a clinical guideline. The probability of lack of adherence is determined by mining a patient record, such as mining from unstructured and/or structured data. The probability is inferred from the results of the mining. The mining may be for a patient record at one facility, but the processor 102 may link patient information to multiple facilities for more comprehensive mining of the patient records. Before or during the appointment, the processor 102 notifies the doctor, nurse, patient or another person or system of the lack of adherence, such as inserting a note in the scheduler or appointment record.

The processor 102 is operable to perform other workflows. For example, the processor 102 initiates contact by electronically notifying a patient in response to identifying a lack of adherence. As another example, the processor 102 requests documentation to resolve ambiguities in a medical record determined by mining. In another example, the processor 102 generates a request for clinical action likely to decrease a probability of lack of adherence. Clinical actions may include a test order, recommended action, request for patient information, other sources of obtaining clinical information or combinations thereof.

To decrease a probability of lack of adherence, the processor 102 may generate a prescription form, clinical order (e.g., test order) or other form requiring authorization from a medical person. The ordered action or medication is identified by the processor 10 as likely to reduce the probability of lack of adherence. The form reminds the medical person of guideline suggestions or requirements, making adherence to a relevant guideline more likely. The form also provides a convenient reminder since the medical person merely signs the form to begin fulfilling guideline requirements.

In a real-time usage, the processor 102 receives current medical information for a patient. Based on the current information and mining the previous patient record, the processor 102 may indicate how to satisfy more likely a guideline during treatment. The actions may then be performed during the treatment or appointment. The processor 102 may output a new indication of adherence to a guideline, such as determining a probability of adherence, of a patient having a particular condition or associated with differential diagnosis.

The processor 102 implements the operations as part of the system 100 or a plurality of systems. A read-only memory (ROM) 106, a random access memory (RAM) 108, an I/O interface 110, a network interface 112, and external storage 114 are operatively coupled to the system bus 104 with the processor 102. Various peripheral devices such as, for example, a display device, a disk storage device (e.g., a magnetic or optical disk storage device), a keyboard, printing device, and a mouse, may be operatively coupled to the system bus 104 by the I/O interface 110 or the network interface 112.

The computer system 100 may be a standalone system or be linked to a network via the network interface 112. The network interface 112 may be a hard-wired interface. However, in various exemplary embodiments, the network interface 112 may include any device suitable to transmit information to and from another device, such as a universal asynchronous receiver/transmitter (UART), a parallel digital interface, a software interface or any combination of known or later developed software and hardware. The network interface may be linked to various types of networks, including a local area network (LAN), a wide area network (WAN), an intranet, a virtual private network (VPN), and the Internet.

The instructions and/or patient record for mining and/or performing workflows are stored in a computer readable memory, such as the external storage 114. The same or different computer readable media may be used for the instructions and the patient record data. The external storage 114 may be implemented using a database management system (DBMS) managed by the processor 102 and residing on a memory such as a hard disk, RAM, or removable media. Alternatively, the storage 114 is internal to the processor 102 (e.g. cache). The external storage 114 may be implemented on one or more additional computer systems. For example, the external storage 114 may include a data warehouse system residing on a separate computer system, a PACS system, or any other now known or later developed hospital, medical institution, medical office, testing facility, pharmacy or other medical patient record storage system. The external storage 114, an internal storage, other computer readable media, or combinations thereof store data for at least one patient record for a patient. The patient record data may be distributed among multiple storage devices or in one location.

The instructions for implementing the processes, methods and/or techniques discussed herein are provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU or system. Because some of the constituent system components and method steps depicted in the accompanying figures are preferably implemented in software, the actual connections between the system components (or the process steps) may differ depending upon the manner in which the present invention is programmed.

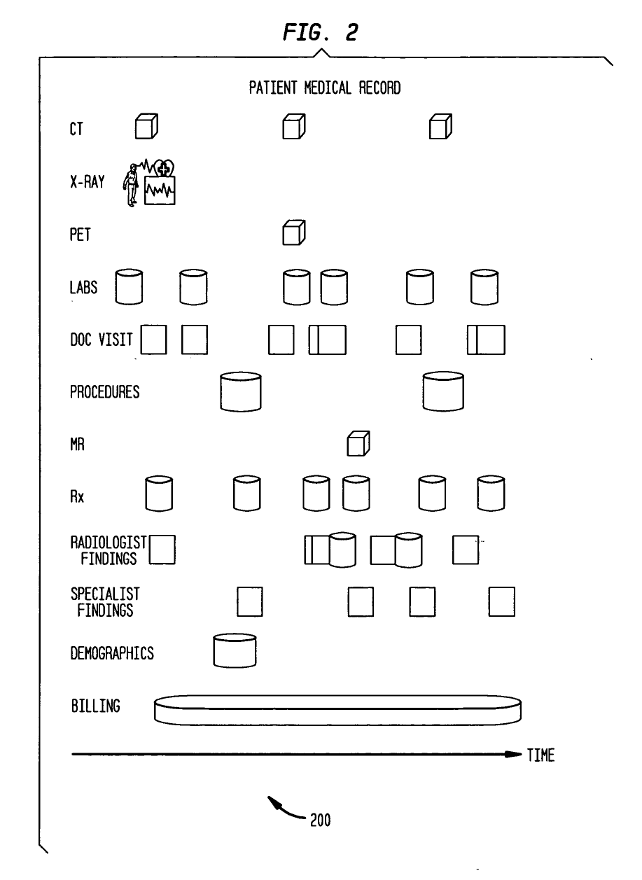

Increasingly, health care providers are employing automated techniques for information storage and retrieval. The use of a computerized patient record (CPR) to maintain patient information is one such example. As shown in FIG. 2, an exemplary CPR 200 includes information collected over the course of a patient's treatment or use of an institution. This information may include, for example, computed tomography (CT) images, X-ray images, laboratory test results, doctor progress notes, details about medical procedures, prescription drug information, radiological reports, other specialist reports, demographic information, family history, patient information, and billing (financial) information.

A CPR may include a plurality of data sources, each of which typically reflects a different aspect of a patient's care. Alternatively, the CPR is integrated into one data source. Structured data sources, such as financial, laboratory, and pharmacy databases, generally maintain patient information in database tables. Information may also be stored in unstructured data sources, such as, for example, free text, images, and waveforms. Often, key clinical findings are only stored within unstructured physician reports, annotations on images or other unstructured data source.

Referring to FIG. 1, the processor 102 executes the instructions stored in the computer readable media, such as the storage 114. The instructions are for mining patient records (e.g., the CPR), adherence to a clinical guideline, assessment for clinical trial, assessment for treatment, assessment of compliance, other functions, or combinations thereof.

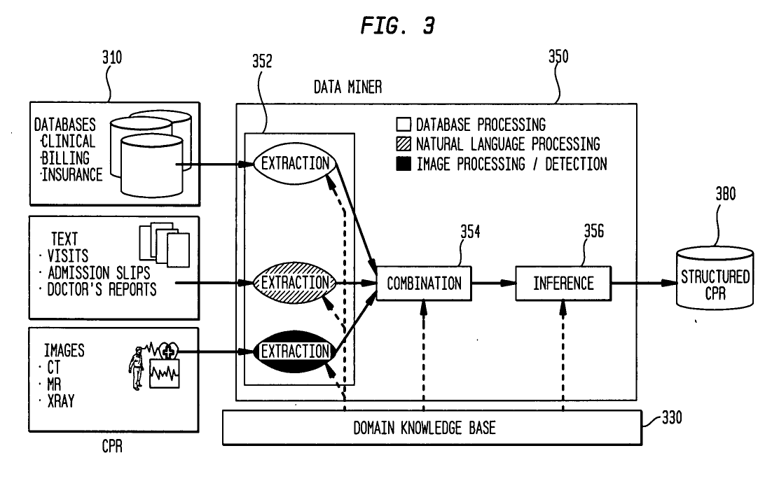

Any technique may be used for mining the patient record, such as structured data based searching. In one embodiment, the methods, systems and/or instructions disclosed in U.S. Published Application No. 2003/0120458 are used, such as for mining from structured and unstructured patient records. FIG. 3 illustrates an exemplary data mining system implemented by the processor 102 for mining a patient record to create high-quality structured clinical information. The processing components of the data mining system are software, firmware, microcode, hardware, combinations thereof, or other processor based objects. The data mining system includes a data miner 350 that mines information from a CPR 310 using domain-specific knowledge contained in a knowledge base 330. The data miner 350 includes components for extracting information from the CPR 352, combining all available evidence in a principled fashion over time 354, and drawing inferences from this combination process 356. The mined information may be stored in a structured CPR 380. The architecture depicted in FIG. 3 supports plug-in modules wherein the system can be easily expanded for new data sources, diseases, and hospitals. New element extraction algorithms, element combining algorithms, and inference algorithms can be used to augment or replace existing algorithms.

The mining is performed as a function of domain knowledge. Detailed knowledge regarding the domain of interest, such as, for example, a disease of interest, guides the process to identify relevant information. This domain knowledge base 330 can come in two forms. It can be encoded as an input to the system, or as programs that produce information that can be understood by the system. For example, a clinical guideline to diagnosing a particular disease or diseases provides information relevant to the diagnosis. The clinical guideline is used as domain knowledge for the mining. Additionally or alternatively, the domain knowledge base 330 may be learned from test data as a function or not as a function of an otherwise developed clinical guideline. The learned relationships of information to a diagnosis may be a clinical guideline.

The domain-specific knowledge may also include disease-specific domain knowledge. For example, the disease-specific domain knowledge may include various factors that influence risk of a disease, disease progression information, complications information, outcomes and variables related to a disease, measurements related to a disease, and policies and guidelines established by medical bodies.

The information identified as relevant by the clinical guideline provides an indication of probability that a factor or item of information indicates or does not indicate a particular diagnosis. The relevance may be estimated in general, such as providing a relevance for any item of information more likely to indicate a diagnosis as 75% or other probability above 50%. The relevance may be more specific, such as assigning a probability of the item of information indicating a particular diagnosis based on clinical experience, tests, studies or machine learning. The domain knowledge indicates elements with a probability greater than a threshold value of indicating the patient state or diagnosis. Other probabilities may be associated with combinations of information.

Domain-specific knowledge for mining the data sources may include institution-specific domain knowledge. For example, information about the data available at a particular hospital, document structures at a hospital, policies of a hospital, guidelines of a hospital, and any variations of a hospital. The domain knowledge guides the mining, but may guide without indicating a particular item of information from a patient record.

The extraction component 352 deals with gleaning small pieces of information from each data source regarding a patient or plurality of patients. The pieces of information or elements are represented as probabilistic assertions about the patient at a particular time. Alternatively, the elements are not associated with any probability. The extraction component 352 takes information from the CPR 310 to produce probabilistic assertions (elements) about the patient that are relevant to an instant in time or period. This process is carried out with the guidance of the domain knowledge that is contained in the domain knowledge base 330. The domain knowledge for extraction is generally specific to each source, but may be generalized.

The data sources include structured and/or unstructured information. Structured information may be converted into standardized units, where appropriate. Unstructured information may include ASCII text strings, image information in DICOM (Digital Imaging and Communication in Medicine) format, and text documents partitioned based on domain knowledge. Information that is likely to be incorrect or missing may be noted, so that action may be taken. For example, the mined information may include corrected information, including corrected ICD-9 diagnosis codes.

Extraction from a database source may be carried out by querying a table in the source, in which case, the domain knowledge encodes what information is present in which fields in the database. On the other hand, the extraction process may involve computing a complicated function of the information contained in the database, in which case, the domain knowledge may be provided in the form of a program that performs this computation whose output may be fed to the rest of the system.

Extraction from images, waveforms, etc., may be carried out by image processing or feature extraction programs that are provided to the system.

Extraction from a text source may be carried out by phrase spotting, which requires a list of rules that specify the phrases of interest and the inferences that can be drawn there from. For example, if there is a statement in a doctor's note with the words “There is evidence of metastatic cancer in the liver,” then, in order to infer from this sentence that the patient has cancer, a rule is needed that directs the system to look for the phrase “metastatic cancer,” and, if it is found, to assert that the patient has cancer with a high degree of confidence (which, in the present embodiment, translates to generate an element with name “Cancer”, value “True” and confidence 0.9).

The combination component 354 combines all the elements that refer to the same variable at the same time period to form one unified probabilistic assertion regarding that variable. Combination includes the process of producing a unified view of each variable at a given point in time from potentially conflicting assertions from the same/different sources. These unified probabilistic assertions are called factoids. The factoid is inferred from one or more elements. Where the different elements indicate different factoids or values for a factoid, the factoid with a sufficient (thresholded) or highest probability from the probabilistic assertions is selected. The domain knowledge base may indicate the particular elements used. Alternatively, only elements with sufficient determinative probability are used. The elements with a probability greater than a threshold of indicating a patient state (e.g., directly or indirectly as a factoid), are selected. In various embodiments, the combination is performed using domain knowledge regarding the statistics of the variables represented by the elements (“prior probabilities”).

The patient state is an individual model of the state of a patient. The patient state is a collection of variables that one may care about relating to the patient, such as established by the domain knowledgebase. The information of interest may include a state sequence, i.e., the value of the patient state at different points in time during the patient's treatment.

The inference component 356 deals with the combination of these factoids, at the same point in time and/or at different points in time, to produce a coherent and concise picture of the progression of the patient's state over time. This progression of the patient's state is called a state sequence. The patient state is inferred from the factoids or elements. The patient state or states with a sufficient (thresholded), high probability or highest probability is selected as an inferred patient state or differential states.

Inference is the process of taking all the factoids and/or elements that are available about a patient and producing a composite view of the patient's progress through disease states, treatment protocols, laboratory tests, clinical action or combinations thereof. Essentially, a patient's current state can be influenced by a previous state and any new composite observations.

The domain knowledge required for this process may be a statistical model that describes the general pattern of the evolution of the disease of interest across the entire patient population and the relationships between the patient's disease and the variables that may be observed (lab test results, doctor's notes, or other information). A summary of the patient may be produced that is believed to be the most consistent with the information contained in the factoids, and the domain knowledge.

For instance, if observations seem to state that a cancer patient is receiving chemotherapy while he or she does not have cancerous growth, whereas the domain knowledge states that chemotherapy is given only when the patient has cancer, then the system may decide either: (1) the patient does not have cancer and is not receiving chemotherapy (that is, the observation is probably incorrect), or (2) the patient has cancer and is receiving chemotherapy (the initial inference—that the patient does not have cancer—is incorrect); depending on which of these propositions is more likely given all the other information. Actually, both (1) and (2) may be concluded, but with different probabilities.

As another example, consider the situation where a statement such as “The patient has metastatic cancer” is found in a doctor's note, and it is concluded from that statement that <cancer=True (probability=0.9)>. (Note that this is equivalent to asserting that <cancer=True (probability=0.9), cancer=unknown (probability=0.1)>).

Now, further assume that there is a base probability of cancer <cancer=True (probability=0.35), cancer=False (probability=0.65)> (e.g., 35% of patients have cancer). Then, this assertion is combined with the base probability of cancer to obtain, for example, the assertion <cancer=True (probability=0.93), cancer=False (probability=0.07)>.

Similarly, assume conflicting evidence indicated the following:

1. <cancer=True (probability=0.9), cancer=unknown probability=0.1)>

2. <cancer=False (probability=0.7), cancer=unknown (probability=0.3)>

3. <cancer=True (probability=0.1), cancer=unknown (probability=0.9)> and

4. <cancer=False (probability=0.4), cancer=unknown (probability=0.6)>.

In this case, we might combine these elements with the base probability of cancer <cancer=True (probability=0.35), cancer=False (probability=0.65)> to conclude, for example, that <cancer=True (prob=0.67), cancer=False (prob=0.33)>.

Numerous data sources may be assessed to gather the elements, and deal with missing, incorrect, and/or inconsistent information. As an example, consider that, in determining whether a patient has diabetes, the following information might be extracted:

(a) ICD-9 billing codes for secondary diagnoses associated with diabetes;

(b) drugs administered to the patient that are associated with the treatment of diabetes (e.g., insulin);

(c) patient's lab values that are diagnostic of diabetes (e.g., two successive blood sugar readings over 250 mg/d);

(d) doctor mentions that the patient is a diabetic in the H&P (history & physical) or discharge note (free text); and

(e) patient procedures (e.g., foot exam) associated with being a diabetic.

As can be seen, there are multiple independent sources of information, observations from which can support (with varying degrees of certainty) that the patient is diabetic (or more generally has some disease/condition). Not all of them may be present, and in fact, in some cases, they may contradict each other. Probabilistic observations can be derived, with varying degrees of confidence. Then these observations (e.g., about the billing codes, the drugs, the lab tests, etc.) may be probabilistically combined to come up with a final probability of diabetes. Note that there may be information in the patient record that contradicts diabetes. For instance, the patient has some stressful episode (e.g., an operation) and his blood sugar does not go up.

The above examples are presented for illustrative purposes only and are not meant to be limiting. The actual manner in which elements are combined depends on the particular domain under consideration as well as the needs of the users of the system. Further, while the above discussion refers to a patient-centered approach, actual implementations may be extended to handle multiple patients simultaneously. Additionally, a learning process may be incorporated into the domain knowledge base 330 for any or all of the stages (i.e., extraction, combination, inference).

The system may be run at arbitrary intervals, periodic intervals, or in online mode. When run at intervals, the data sources are mined when the system is run. In online mode, the data sources may be continuously mined. The data miner may be run using the Internet. The created structured clinical information may also be accessed using the Internet. Additionally, the data miner may be run as a service. For example, several hospitals may participate in the service to have their patient information mined, and this information may be stored in a data warehouse owned by the service provider. The service may be performed by a third party service provider (i.e., an entity not associated with the hospitals).

Once the structured CPR 380 is populated with patient information, it will be in a form where it is conducive for answering questions regarding individual patients, and about different cross-sections of patients.

The domain knowledgebase, extractions, combinations and/or inference may be responsive or performed as a function of one or more variables. For example, the probabilistic assertions may ordinarily be associated with an average or mean value. However, some medical practitioners or institutions may desire that a particular element be more or less indicative of a patient state. A different probability may be associated with an element. As another example, the group of elements included in the domain knowledge base for a particular disease or clinical guideline may be different for different people or situations. The threshold for sufficiency of probability or other thresholds may be different for different people or situations.

Other variables may be user or institution specific other than domain knowledge of data sources. For example, different definitions of a primary care physician may be provided. A number of visits threshold may be used, such as visiting the same doctor 5 times indicating a primary care physician. A proximity to a patient's residence may be used. Combinations of factors may be used.

The user may select different settings. Different users in a same institution or different institutions may use different settings. The same software or program operates differently based on receiving user input. The input may be a selection of a specific setting or may be selection of a category associated with a group of settings.

The mining, such as the extraction, and/or the inferring, such as the combination, are performed as a function of the selected threshold. By using a different upper limit of normal for the patient state, a different definition of information used in the domain knowledge or other threshold selection, the patient state or associated probability may be different. User's with different goals or standards may use the same program, but with the versatility to more likely fulfill the goals or standards.

Various outputs may be used. For compliance monitoring, a statistical summary of clinical information for a plurality of patients may be output. See U.S. Published Application No. 2003/0125984, the disclosure of which is incorporated herein by reference, for extraction of compliance information by patient data mining. The compliance may indicate a number, percentage, mean, median or other statistic of patients satisfying, not satisfying or with unknown adherence to a clinical guideline. The patients associated with a particular diagnosis are identified, such as by manual indication, billing code or other input. In one embodiment, patient data mining identifies patients associated with a diagnosis from one or more data sources. Even patients who should have been diagnosed but were not may be identified. Once the patients are identified, compliance with a corresponding clinical guideline is determined. Manual or automated compliance may be used. The statistical summary may be responsive to inferences, such as where patient data mining is used.

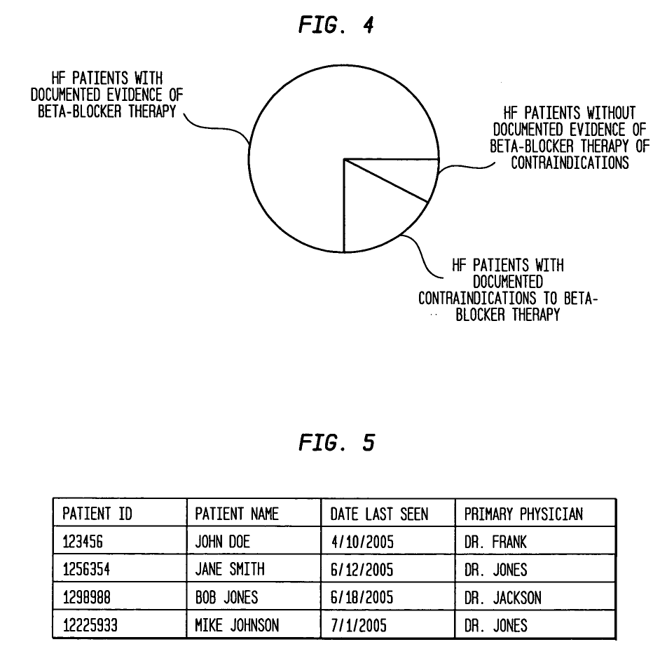

The compliance information is summarized. Any summary may be provided, such as a table, chart, graph or combinations thereof. For example, FIG. 4 shows a pie chart for the results of the guideline regarding beta-blocker usage for heart failure. This graph represents a summary statistic which may be useful for a hospital administrator or medical professional. About 83% of the patient records include an indication of a heart failure patient having received beta-blocker therapy. About another 12% of the patient records include an indication of a contraindication to beta-blocker therapy. However, about 6% of the patient records do not include a sufficient indication of beta-blocker therapy or a contraindication. Other statistical summaries may be used, such as identifying patient records associated with more complex guidelines.

The output is graphical or textual. The output may be printed. In one embodiment, the output is displayed as part of a user interface allowing interaction. The interaction allows a user to obtain information supporting the summary statistics of quality adherence. In the example of FIG. 4, a user may desire to determine which patients are not being treated properly, which doctors are associated with deviations from the clinical guideline, or where documentation of proper treatment is not being entered.

The user selects a portion of the statistical summary. In the example of FIG. 4, the computer or system receives an indication of a selected pie chart wedge. The user navigates to the wedge, such as selecting the wedge with a mouse and pointer. Other selections may be received, such as selection of a cell, row or column on a table, selection of a location along an axis of a chart or graph, or combinations thereof. Other navigation may be used, such as tabbing or depressing a particular key, to select portions of the summary.

In response to the selection, data supporting the statistical summary is output. The data is for the selected portion, or includes support for the selected portion output with but distinguished (e.g., highlighted, colored, bolded or with a different font) from other data. Another summary with more detail may be output. In one embodiment, a table listing the patients, doctors and/or other information associated with the selected statistic is output. FIG. 5 shows an example table output in response to selection of the 6% wedge of FIG. 4. The table lists the patients, doctors, and dates associated with the patients for which treatment appears not to have satisfied the clinical guideline.

Further refinement may be possible. For example, the user interface may provide for automated or assisted generation of a notice to the relevant physician to follow-up or assure proper treatment or documentation.

As another example, user selection of a patient or other information on the supporting data summary is received. In response, further details are output. Specifics of the patient are output, such as outputting the data mining elements or factoids in response to selection of a patient on the list. For example, by selecting John Doe, this person's records and/or the output of the data mining is displayed. A user interface for display of supporting information for data mining is described in “A System and Workflow for Quality Metric Extraction” by Krishnan et al, (Ser. No. 60/771,684). The user interface may be used to display further information, such as the supporting patient record, with respect to a selected patient. The supporting patient information may be sorted or arranged for ease of use, such as highlighting related information.

Other outputs may aid a user in understanding adherence to a clinical guideline or other association of elements or factoids to a patient state. A visual representation of the relationship of the patient state to the patient record may assist user understanding. The visual representation is output on a display or printed. The visual representation of the relationship links elements or factoids to the resulting patient state or other conclusions. The clinical guideline may be represented visually, and supporting information from a specific patient record inserted. A pictorial representation of the extraction, probabilistic combination, inferences or combinations thereof may assist the user in general understanding of how any conclusions are supported by inputs. For example, fever and chill inputs mined from a patient record are shown connected to or linked with an output of flu.

The visual representation shows the dependencies between the data and conclusions. The dependencies may be actual or imaginary. For example, a machine learning technique may be used. The relationship of a given input to the actual output may be unknown. To assist in user understanding, a relationship may be graphically represented without actual dependency, such as probability or relative weighting, being known.

The visual representation may have any number of inputs, outputs, nodes or links. The types of data are shown. Other information may also be shown, such as inserting actual states of the data (e.g., fever as a type of data and 101 degrees as the actual state of the fever information). The relative contribution of an input to a given output may be shown, such as colors, bold, or breadth of a link indicating a weight. The data source or sources used to determine the actual state of the data may be shown (e.g., billing record, prescription database or others). Alternatively, only the type of data and links or other combination of information are shown.

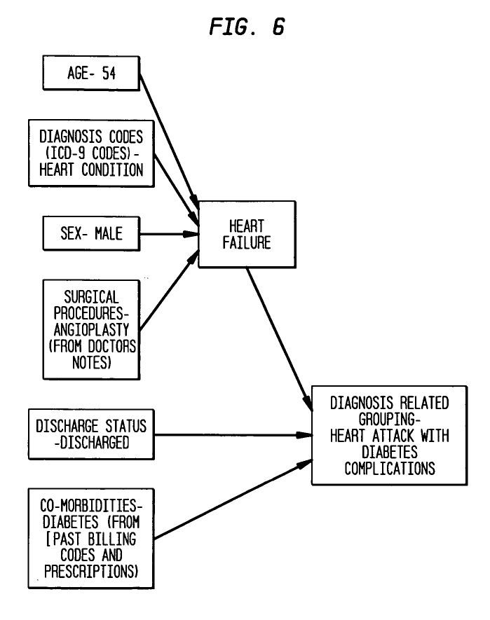

FIG. 6 shows one example of a visual representation related to heart failure treatment. Elements of the patient record used to infer the patient state link to the patient state. An additional node for a diagnosis related grouping is shown. The heart failure patient state is an input to the diagnosis related grouping state. The actual conclusion of heart failure or merely one or more of the inputs associated with the heart failure may actually be used for inferring the diagnosis related grouping state. The links (e.g., lines, arrows or other connectors) provide a flow chart graph representing the relationship. Any visual representation of the relationship may be used.

The visual represention may be different for different patients. For example, different patients have data in different data sources. A same factoid may be derived from different locations, so the display of the data source may be different. A different set of elements may be used to infer a same or different patient state, so different elements or types of data are shown. Different actual states may be shown. Different links may exist even to reach a same conclusion or patient state. The probability associated with a patient state, element or factoid may be different, so the visual representation may also be different to reflect the probability (e.g., different color, line width, displayed percentage or other visual queue).

As another example, the level of detail may be different for different users. A visual representation for a patient may include only the elements, nodes and links. The same patient record may be used to generate a visual representation for a physician with the relative weights and probability information. The number of elements, nodes or links may be different.

The patient data mining, with or without the user interfaces or outputs discussed above, may be associated with a healthcare workflow. For example, patient data mining is used to review a patient record, and the output of the data mining is used to initiate or trigger a workflow based on a particular criteria. The patient data mining initiates the workflow without an external query. As another example, the workflow queries the patient data mining or the associated results. After the data mining is completed, the resulting structured information may be queried automatically to find one or more items. The workflow depends on, at least in part, the findings of the data mining. The workflow is a separate application that queries the results of the patient data mining and uses these results or is included as part of the data mining application. Any now known or later developed software or system providing a workflow engine may be configured to initiate a workflow based on data.

In one embodiment, quality adherence to a clinical guideline is used as part of a healthcare workflow. The patient record is mined to determine quality adherence, such as disclosed in U.S. Published Application No. 2003/0125985, the disclosure of which is incorporated herein by reference. The system includes an output component for outputting quality adherence information. The output quality adherence information may include reminders, including reminders to take clinical actions in accordance with the clinical guidelines. The output quality adherence information may also include warnings or alerts that the clinical guidelines have not been observed.

The quality adherence engine may be configured to monitor adherence to the clinical guidelines by comparing clinical actions with clinical guidelines as part of the knowledgebase. The clinical guidelines can relate to recommended clinical actions. The quality adherence engine can monitor adherence to the clinical guidelines by determining the next recommended clinical actions. Reminders for the next recommended clinical actions can be output so that health care providers are better able to follow the recommendations.

The patient records contained in the data sources may include information regarding clinical actions taken during patient treatments. For example, the patient records may contain information regarding various tests and procedures administered to the patient.

Since the mined clinical action information may be a product of inferences, the information may be probabilistic. The warnings may be generated if there is a likelihood that the guidelines have or have not been followed. Probability values may be assigned to each clinical action, and warnings issued if the probability that the guidelines were not followed exceeds a predefined threshold.

The quality adherence engine may also monitor adherence to clinical guidelines by determining the next recommended clinical actions. Reminders for the next recommended clinical actions may be output so that health care personnel are better able to follow the recommendations. For example, guidelines for treatment of acute myocardial infarction (AMI) promulgated by the Joint Commission on Accreditation of Healthcare Organizations (JCAHO) call for certain AMI patients without aspirin contraindication to receive aspirin within 24 hours before or after hospital arrival. In this example, the quality adherence engine selects patient records for one or more AMI patients from the data sources, and generates a reminder that aspirin should be given to certain of those patients. If the 24 hour period expired without aspirin being provided to an AMI patient, then a warning may instead be output.

Adherence to clinical guidelines may be automatically ensured during the course of patient treatments. The patient record is mined, such as through extraction, combination and inference as discussed above. The relevant clinical guideline or guidelines are retrieved from a clinical guidelines knowledgebase. For example, the clinical guidelines may be stored in a database, and contain recommended clinical actions for various diseases of interest. These clinical guidelines may include recommendations promulgated by accreditation organizations (such as JCAHO), government agencies, and consumer health care organizations. In addition, clinical guidelines may be created for internal use (e.g., by a hospital to measure quality of care). In general, clinical guidelines may include any list of recommended clinical actions. The clinical guidelines may be used as part of the knowledgebase for mining.

Adherence to the clinical guidelines is monitored. This may involve determining the current patient diagnosis, and comparing clinical actions taken with respect to the patient to relevant guidelines. If recommended clinical actions were not observed, warnings may be generated to physicians and other medical personnel. The recommended next clinical actions for the patient may also be determined, and reminders may be generated. Quality adherence information, such as the reminders and warnings, may be output via a report, a computer display, or even integrated into a calendar or scheduling system.

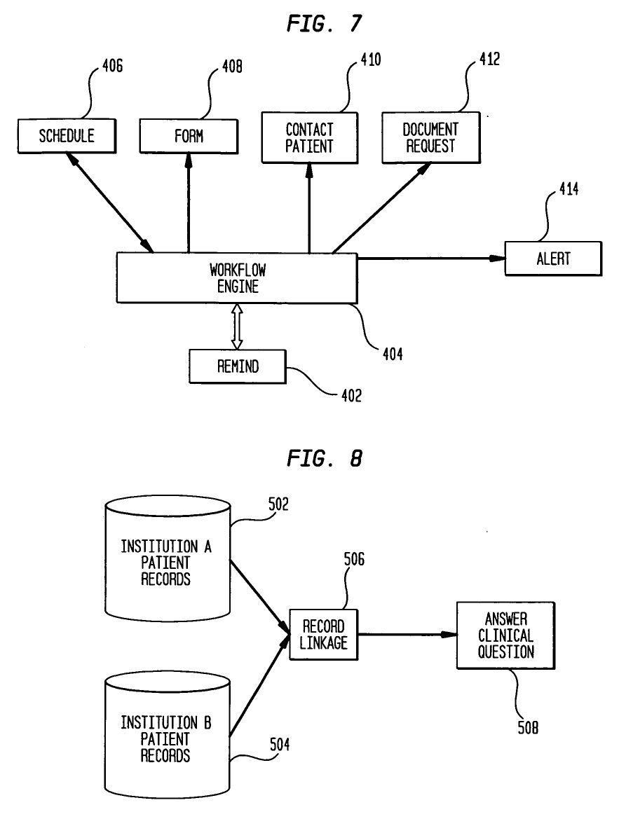

One example workflow 404 (see FIG. 7) associated with quality adherence is patient scheduling 406. The workflow system queries whether guidelines were met for a particular patient in response to a scheduled appointment. The workflow 404 (e.g., periodic automated review of the schedule) or mere entry of an appointment for a particular patient triggers patient data mining 402. Patients who are going to be seen on a particular day or that week may have an alert 414 attached to their appointment associated with quality adherence. The alert 414 may be, for example, a print-out, e-mail, electronic notice, schedule entry, notice associated with a file or patient record, or other flag given to the physician or nurse. The alert 414 lets the clinicians know that there is a potential guideline adherence issue to be resolved. For example, it is known that patients who have heart failure should either be taking beta-blockers, or have a documented contraindication to beta-blockers. The system identifies one or more patients who do not meet these guidelines (i.e. heart failure patients who are not on beta-blockers or not taking contra-indications), and generates an alert any time an appointment is made or about to occur for the patient.

The same workflow 404 or other workflows described herein may be associated with other processes, such as identifying patients for clinical trials or eligibility for a particular therapy. The scheduling 406 prompts determination of qualification of the patient. The alert 414 allows the medical practitioners to look into possibilities or further clinical actions during or prior to the appointment.

Another example workflow 404 is based on a lack of adherence to a clinical guideline. A probability of lack of adherence or other indicator of lack of adherence is determined, such as with patient data mining 402. The lack of adherence is based on a sufficiently high probability of no adherence or lack of information to determine a sufficiently supported probability. Rather than a probability, the lack of adherence may be binary, such as no evidence suggesting fulfilling at least one portion of the clinical guideline or conflicting evidence.

Where patient data mining 402 indicates a lack of adherence, a request for documentation 412 may be generated. The request 412 may be placed in the electronic patient record. The request 412 may be in addition to an alert 414 or notice of failure to adhere. For example, the patient data mining 402 may indicate or leave room for possible adherence. A probability of adherence may be sufficiently high but below a threshold indicating actual adherence. An expected source of information may not indicate adherence, but another source does, such as a prescription record not showing a prescription but physician notes indicating prescription.

The request for documentation 412 may be used to more likely generate or have complete medical records. The request 412 is communicated to the physician, the patient or other person involved in treatment. The request 412 is electronic, paper or audible. The request 412 indicates a lack of adherence, but additional information about the conflicts, missing data or other patient record references may be provided. For example, a notice of inadequate probability or missing information is sent. By indicating inadequate probability of adherence, lack of appropriate documentation, discrepancy in data sources, or other lack of adherence in a request, the documentation may be added to the patient record. Where the problem is not a lack of documentation, but an actual lack of adherence, the request may lead to adherence to the clinical guideline.

In one example for heart failure patients, one of the questions that must be documented is if the patient is a smoker or not. If that information is not available, a workflow 404 is generated to fill in that documentation 412, whether by sending an alert to a nurse or other clinician to contact 410 the patient, or an email or call to the patient to contact the healthcare institution to finish documentation. Documentation may also include internal documentation. If there is no evidence that a lab was done, a request can be sent to search other records to find evidence of the lab work. Furthermore, the answers to these questions may generate other questions to be answered. For example, if the answer to the question above was that the patient was a smoker, this may initiate other questions such as whether the patient was given smoking cessation counseling.

Rather than or in addition to a request for documentation 412, a form 408 including a clinical action or prescription is generated. A lack of adherence may be a result of not fulfilling the clinical guideline, such as a lack of actual adherence. The same or different notice than used to request documentation 412 or for scheduling 406 may include a suggested clinical action, such as a test or prescription. The clinical action or prescription would lead to at least more likely fulfillment of the clinical guideline. For example, the patient data mining 402 identifies one or more tests, prescriptions or other acts for which there is no or insufficient indication of having occurred. A prescription form for a medication is generated with a location for signature. Alternatively or additionally, a form for clinical action with a location for signature is generated. Clinical actions include a test order, recommended action, request for patient information or combinations thereof. By including the prescription or the clinical action on the form, the physician or other medical practitioner may more easily provide treatment adhering to the clinical guideline.

The form 408 may also include a location for authorization, such as a signature line for a treating physician. The name of the physician is automatically or manually inserted adjacent the authorization location. In the above example for beta-blockers, a prescription is generated for the physician to sign and hand to the patient. This would assist in their workflow. The physician verifies whether the clinical action or prescription indicated by the form is desired. If desired as indicated by the patient data mining 402, the form 408 is signed. Other actions may occur in the workflow 404, such as providing for digital signature or other computer input showing authorization and automatic scheduling or contacting the patient in response.

The form 408 is generated in response to the workflow 404. The workflow 404 may be responsive to scheduling 406, generation of statistical summaries for compliance or other reasons for mining data associated with a particular patient. The workflow 404 may be initiated by the physician before, during or after an appointment. The workflow 404 is part of an automated or manual process.

Another workflow 404 includes contacting the patient 410, such as to obtain missing documentation 412, provide a form 408, schedule 406 a test, issue an alert 412 or for other reasons. The contact 410 is initiated, at least in part, in response to the lack of adherence. The lack of adherence or qualification for a clinical trial is identified for any reason in the workflow 404. For example, the lack of adherence is determined in response to a regular or scheduled search for lack of adherence. As another example, the lack of adherence is determined as part of compliance study. In another example, a new clinical trial guideline is entered into the system, and the patient is identified based on mining 402 for patients qualified for the clinical trial.

The contact 410 is an e-mail, voice response, mail or combinations thereof. Any of the alert 414, document request 412, form 408 or notice related to scheduling 406 may be provided directly to the patient. For example, an alert, email or phone call is performed automatically, in response to mining 402, to schedule a visit, or try to collect information by the phone in order to gather more or missing information.

In another embodiment, the contact 410 with the patient is initiated by providing information about lack of adherence or qualification for a clinical trial to a nurse, physician, administrator or other person responsible for contacting patients. The person is alerted with a notice indicating the patient, the lack of adherence and a request to contact the patient. An alert or email could be sent to a nurse or other user to contact these patients and schedule a visit. For example, if a patient may be eligible for a trial, a trial coordinator may contact 410 the patient and question them over the phone based on the results of mining 402. If the patient is truly eligible and willing, the patient is called in for a visit.

The workflows 404 are performed prior to, during or after patient treatment or a specific appointment. In one embodiment, the workflow 404 is performed, at least in part, in real-time with patient treatment or an appointment. During the actual patient visit, the workflow 404 with the patient data mining 402 is performed in real-time. As the physician or nurse asks the patient questions, the answers to the questions, combined with the previous patient data, may initiate new questions to be asked, or suggest a test that should be done to answer a question.

Data is input to the system or computer at the time of treatment of the patient. For example, the user enters the current temperature, blood pressure, prescribed drugs, test results, other patient information or combinations thereof. The system receives the input data.

A probability of a particular disease or guideline adherence is determined as a function of the input data and data for a previously acquired patient record. The input data is included as part of the patient record for extraction, combination and/or inference. The probability may be a binary determination, such as whether the patient record including the data entered at the time of treatment indicates a given diagnosis. The mining 402 determines whether a patient record and associated data corresponds to a particular condition and associated clinical guideline or trail conditions.

The mining may be for a plurality of guidelines, clinical trials and/or therapies. The patient visits a healthcare institution. The patient's data is entered into the patient record. Using mining 402, the patient record is matched against guidelines, therapies, and clinical trials. For example, if a patient walks in with chest pain, and they have a history of diabetes and smoking (from their previous records), then the likelihood that the patient has coronary artery disease or angina is high. The mining 402 outputs, based on the initial symptoms and history from previous records, possible or probable diagnoses and associated clinical guidelines, trials or therapies.

A probability is determined for one or more possible guidelines, clinical trails and/or therapies. Where a patient record including currently input information indicates two or more likely diagnoses, clinical trial condition satisfaction, and/or applicability of therapies, the differential information is output. The system performs differential diagnosis in real-time, suggesting the likelihood of a particular disease. Alternatively, the mining is performed for only one guideline, clinical trial condition set and/or therapy. For example, the physician selects a clinical guideline based on perceived diagnosis. The physician uses the results of the mining 402 to confirm the perception.

The workflow 404 includes the system or computer suggesting additional information to be obtained which may change one or more of the probabilities. The additional information may further clarify (increase or decrease) the probability of a particular diagnosis or adherence. The additional information may distinguish between the possible diseases. The additional information is a test or other order, a recommended action, a request for patient information or combinations thereof. For example, the information is output to the user in an alert 414, documentation request 412, or form 408 discussed herein. The system suggests further questions to improve understanding of whether the patient meets diagnosis, guidelines, therapy requirements, or clinical trials conditions. For example, a physician enters a prescription of a medication A. Based on mining using the input data, the system suggests a prescription for medication B instead due to a contraindication in the history or drug interaction, making fulfillment of a clinical guideline more likely. The adherence is performed at the time of treatment, avoiding complications.

Additional data is received, such as receiving information, test results or other data in response to the suggestion to acquire additional information. The additional data is received at the time of the treatment of the patient. For example, if the patient is being treated for angina, the system may suggest questions or lab tests to ensure that the patient is being treated per guidelines (e.g., the patient should be given aspirin as per guidelines). Once the patient receives the aspirin or instructions to take aspirin, the system is updated. The update includes the additional information that the patient has received or been instructed to take aspirin.

The mining 402 is performed again with the additional information. The mining 402 occurs in response to the input of the information, a user trigger or other trigger. Another probability is determined based on the additional information. Other probabilities for other diagnoses may be determined. The likelihood of disease may change in real-time based on any new or real-time input. As more information from or about the patient (e.g., lab values, results of EKG, family history or other information) is received, the likelihood of diagnosis may change. The diagnosis, probability or other results are presented to the physician in real-time to assist in treatment. The system may suggest obtaining further additional information, such as a new test (e.g., blood tests to determine troponin levels) to further refine the diagnosis.

Further workflow 404 is initiated if one of the probabilities for a particular diagnosis or meeting some requirements is above a threshold. For example, a clinical guideline is identified based on the diagnosis. The clinical guideline is output by the system or treatment is monitored for adherence by the system. Alternatively, arrangements for participation in a clinical trial are begun, such as outputting clinical trial information, contact information, permission forms, participation forms or other information associated with the clinical trial.

One example of this further workflow 404 is a patient visit to a hospital. The patient arrives at a hospital with chest pain. Most hospitals have clear guidelines and workflows, for example, for patients with specific cardiac diseases, such as heart failure, unstable angina, AMI, or others. In these cases, certain data must be collected, and certain things must be done to the patient, such as giving them aspirin with 24 hours. However, if a patient has chest pain, and there is no indication of what is causing the chest pain, then these workflows may not necessarily be initiated. Currently gathered information and previous medical records are mined to infer the disease. This can be done in real-time by combining the patient history with information being collected at the hospital. Once a likelihood of a disease exceeds a certain threshold, a workflow is initiated based on the workflow engine. For example, if it is determined that a patient with chest pain probably has AMI, then the AMI workflow is initiated. The AMI workflow may include collection of information (including collection of information for quality metrics like JCAHO and CMS), and initiation of tests and therapies, such as administration of aspirin.

The patient data mining 402 operates in real-time or during treatment. The operation assists in identifying a condition and initiates a workflow based on the condition. The system may continue to assist in adherence to a clinical guideline for the workflow.

In some situations, the patient record may be distributed or stored at different institutions. Different institutions include doctor's offices, hospitals, health care networks, clinics, imaging facility or other medical group. The different institutions have separate patient records, but may or may not be affiliated with each other or co-owned. In order to mine the patient record, the patient records from the different institutions are linked.

As an example, consider the following guideline from The Specifications Manual for National Hospital Quality Measures. If a patient is admitted to the hospital with a primary diagnosis of heart failure, then there should be documentation of left ventricular systolic function (LVSF) assessment at any time prior to arrival or during the hospitalization. First, the hospital records are searched to find patients who were admitted with a primary diagnosis of heart failure. This can be done by searching the records (e.g., billing records and/or other data sources) of a hospital. To assess the second part, however, is a little more complicated. If a mention of LVSF assessment exists in the hospital records, as part of the history, discharge summary, or somewhere else, then the guideline can be assessed from the hospital data alone. Often, however, the data is not available there, but elsewhere. For example, if the patient was referred to the hospital by his cardiologist, who performed the LVSF assessment in his office the previous day, then the record of LVSF assessment is with the physician in his practice notes. If the LVSF assessment was done at one hospital, and then the patient was transferred to the current hospital, then the record of the LVSF assessment is with the previous hospital.

FIG. 8 shows two institutions A and B (502, 504) with one or more databases of patient records. To provide more complete automated assessment, the patient records from the two institutions are linked. The process occurs for mining any patient record. Alternatively, the process occurs only once the current patient record at a facility is deemed insufficient, such as not adhering to a guideline.

To begin the process, the patient is identified. A patient code, social security number, name and/or other information is input to identify the patient. The system receives the input. The patient may have been assigned different patient identification numbers (patient IDs) at different institutions. For example, at the hospital, the patient may be patient # 12345. At his physician's office, the patient records may be stored electronically as patient # 44. Typographical errors may result in different reference information to identify the patient record, such as the social security number or name being different at the two institutions despite being for the same person.

In order to combine this information together, the records are linked together. Nurses or other medical professionals often link manually by looking at names, addresses, social security numbers, or other pieces of information. For a processor or system implementation, a record linkage 506 links the patient to a one patient record at one institution and another patient record as another institution. The records are linked based on the input information, such as the patient ID, social security number or name with date of birth. Where this information matches at different institutions, the records may be linked. Further processes may be provided, such as copying the linked records from one or more institutions to a database for mining.

Where the patient identification input does not match, such as due to typographical error or other discrepancy, the record linkage 506 may account for the error or discrepancy to link the patient records. For example, if the two digits of the social security number are interposed in one of the records, the record linkage 506 links the patient records. The record linkage 506 combines records from different sources when one or more primary keys (such as a patient ID) do not match. The record linkage 506 provides a key to match the electronic master patient index (EMPI) between two different institutions (or two different sets of patient indices). Any now known or later developed technique for linking the patient records may be used. In one embodiment, a probabilistic framework is used to identify which records are linked. Examples are described in Automatic Blocking Keys Selection (U.S. Patent Application Publication No. 2005/0246330), Optimizing Database Access for Record Linkage by Tiling the Space of Record Pairs (U.S. Patent Application Publication No. 2005/0246318), Data Sensitive Filtering in Search for Patient Demographic Records (U.S. Provisional Ser. No. 60/686,065, filed May 31, 2005) and Probabilistic Model for Record Linkage (U.S. patent application Ser. No. ______ (Ser. No. 11/255,660, filed Oct. 21, 2005)), the disclosures of which are incorporated herein by reference.

The record linkage 506 links the patient records. The patient records from the two or more different institutions are combined. A clinical question is answered 508 based on the linked information. For example, the combined information is mined to determine a diagnosis, for clinical adherence, for qualification for clinical trial or treatment, for compliance assessment, or for another purpose. The clinical question may be answered from the linked information without combination, such as mining from the different institutions without copying or combining into one patient record. The mining may be performed sequentially, such as mining from one institution first and then mining from the second institution, or performed once by mining from multiple institutions during a same extraction or analysis process. The information from the multiple institutions is used to infer or determine the answer. For example, the different patient records are mined to determine a probability of a particular disease as a function of results of the mining.

The patient data mining may be used to confirm, verify or create billing information. Billing codes are used to generate bills or payment requests from a patient or insurer for particular treatments. A diagnosis related grouping (DRG) is an alternative to procedure based billing codes. A patient is categorized into a DRG based on a number of different pieces of information, including diagnosis codes (ICD-9 codes), co-morbidities, surgical procedures, age, sex, and discharge status of the patient. Acute care hospitals may be paid a flat fee for each patient based on their DRG. It is important to categorize patients correctly. Furthermore, if the secondary diagnosis codes are not correctly reflected, then the co-morbidities may not be done correctly. Incorrect co-morbidities may result in a lower paying DRG. Patient data mining is used to determine the DRG or to compare an inferred DRG to the DRG assigned to the patient. The determination is used for individual records or as part of comprehensive assessment of the quality of the DRG or associated data records.

The system determines billing information periodically, in response to a trigger, based on user activation, or in response to another input. The system searches patient records, identifies DRG related information for the patient, and determines one or more DRGs supported by the patient record. Alternatively, the system may find billing codes or DRG considerations for which there is no supporting evidence. For example, if an ultrasound exam was performed, but there is no record of an ultrasound report, and there is no mention of the results of the ultrasound, and there are no ultrasound images in the hospital PACS system, then the system may infer that no exam was performed and an improper DRG assigned.

In one embodiment, the DRG is inferred by mining billing information as disclosed in U.S. Published Application No. 2004/0172297, the disclosure of which is incorporated herein by reference. The system automatically processes medical information in electronic patient medical record databases to extract billing information. Billing information is extracted by comprehensive analysis of clinical information in the patient medical records using domain-specific criteria from a domain knowledge base. The domain knowledgebase includes DRG factors and determination criteria. In addition to or as an alternative to billing codes, DRG or associated information is determined.

The system automatically extracts one or more DRGs from the medical record by analyzing the patient information in the medical record using domain-specific criteria. For example, all possible DRGs supported by the patient clinical information in the medical record based on all domain-specific criteria in a domain knowledge base are determined by mining.

When performing automated extraction of billing information, the system may not consider or give significant weight to an assigned DRG. Depending on the domain-specific criteria, other codes related to medical procedures, resources, tests, prescriptions or other clinical actions may be defined as criteria for establishing a particular DRG and/or co-morbidity. In one embodiment, the elements mined include diagnosis codes, co-morbidities, surgical procedures, age, sex, discharge status, or combinations thereof. For example, three or more, such as all, of these elements or other elements relevant for DRG determination are mined. The elements are inferred from other data or are determined by identification with sufficient probability in the medical record.

Multiple diagnoses may be associated with a patient record. By mining for all possible diagnoses or complications, a co-morbidity may be determined. The co-morbidity may result in a different DRG. FIG. 6 shows determining a primary diagnosis, such as heart failure. Co-morbidities and other information used or not used in the diagnosis of the heart failure are used to determine the DRG. The system scans the patient record to identify co-morbidities, and ensure that these co-morbidities are correctly put into the billing record. For example, if a heart failure patient is also a diabetic, but came in for treatment for heart failure, then diabetes should be listed as a co-morbidity.

The results of the mining are used to determine the DRG with or without corresponding probability information. For example, the heart failure diagnosis and/or the supporting elements or factoids are used to determine the DRG.

The system may identify or otherwise extract the DRG recorded in the patient medical record and compares the recorded DRG with the extracted DRG. More specifically, in one exemplary embodiment, a recorded DRG is deemed “correct” and accepted if there is a corresponding extracted DRG based on the patient information (e.g., clinical information). In addition, a recorded DRG is deemed “incorrect” and rejected, if there is an extracted DRG that is contrary to the recorded billing code. The results of the comparison indicate the actual recorded DRG that are “correct” or “incorrect”, as well as an indication as to DRGs that are “missing” and should be included in the patient medical record.

Where multiple, plausible (sufficiently probable) DRGs are supported, the user may be asked to choose, or the system may select the most probable DRG or the DRG associated with a desired payment level. For selection, the supporting information and/or information suggesting different DRGs from the patient record may be provided to the user, such as disclosed in U.S. patent application Ser. No. 10/287,075, filed on Nov. 4, 2002, entitled “Patient Data Mining, Presentation, Exploration and Verification”, which is fully incorporated herein by reference. This application discloses a system and method for generating a graphical user interface for presenting, exploring and verifying patient information. Automated or verified updating of the DRG for payment may be provided.

The DRG is stored as part of the patient record for later use. Alternatively or additionally, a reimbursement workflow is initiated. Forms or bills are generated based on the DRG.

Various improvements described herein may be used together or separately. Any form of data mining or searching may be used. The techniques described for quality adherence, billing, compliance, clinical trial qualification, treatment qualification or other purposed may be used for any now known or later developed purpose.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A system for assisting with adherence to a clinical guideline, the system comprising:
a processor operable to identify an appointment for a patient scheduled to occur in the future; and
at least one memory operable to store at least one patient record for the patient;
wherein the processor is operable to determine with the patient record a probability of lack of adherence of patient treatment to the clinical guideline in response to identification of the appointment, and operable to notify of the lack of adherence before or during the appointment.

2. The system of claim 1 wherein the processor is operable to mine the at least one patient record, including mining unstructured data, the probability inferred from results of the mining.

3. The system of claim 1 wherein the processor is operable to link sources of information from the patient record to the probability and make the link available.

4. The system of claim 1 wherein the processor is operable to generate a request for clinical action likely to decrease the probability of lack of adherence.

5. The system of claim 4 wherein the request comprises a test order, recommended action, request for patient information or combinations thereof.

6. The system of claim 1 wherein the processor is operable to generate a prescription form wherein a medication associated with the prescription form is likely to decrease the probability of lack of adherence.

7. The system of claim 1 wherein the processor being operable to notify comprises the processor being operable to initiate contact.

8. The system of claim 7 wherein initiate contact comprises electronically notify a patient.

9. The system of claim 1 wherein the processor being operable to notify comprises the processor being operable to request documentation.

10. The system of claim 1 wherein the processor is operable to receive input in response to notifying and operable to subsequently perform the determining.

11. In a computer readable storage medium having stored therein data representing instructions executable by a programmed processor for adherence to a clinical guideline, the storage medium comprising instructions for:
mining a patient record including unstructured data;
determining a lack of adherence to the clinical guideline from, at least in part, results of the mining; and
generating a form requiring authorization and including a clinical action or prescription to address, at least in part, the lack of adherence.

12. The instructions of claim 11 wherein mining comprises inferring information.

13. The instructions of claim 11 wherein mining comprises mining as a function of the clinical guideline.

14. The instructions of claim 11 wherein determining the lack of adherence comprises determining a probability for the lack of adherence.

15. The instructions of claim 11 wherein generating comprises generating a prescription form for a medication with a location for signature.

16. The instructions of claim 11 wherein generating comprises generating the form for clinical action with a location for signature.

17. The instructions of claim 16 wherein generating comprises generating a test order, recommended action, request for patient information or combinations thereof.

18. In a computer readable storage medium having stored therein data representing instructions executable by a programmed processor for adherence to a clinical guideline, the storage medium comprising instructions for:
mining a patient record including unstructured data;
determining a lack of adherence to the clinical guideline from, at least in part, results of the mining; and
initiating contact with a patient, at least in part, in response to the lack of adherence.

19. The instructions of claim 18 wherein mining comprises inferring information.

20. The instructions of claim 18 wherein mining comprises mining as a function of the clinical guideline.

21. The instructions of claim 18 wherein determining the lack of adherence comprises determining a probability for the lack of adherence.

22. The instructions of claim 18 wherein initiating comprises contacting the patient with e-mail, voice response, mail or combinations thereof.

23. The instructions of claim 18 wherein initiating comprises alerting a person with a notice indicating the patient, the lack of adherence and a request to contact the patient.

24. In a computer readable storage medium having stored therein data representing instructions executable by a programmed processor for adherence to a clinical guideline, the storage medium comprising instructions for:
mining a patient record including unstructured data;
determining an indication in the patient record of an inadequate probability of adherence to the clinical guideline from, at least in part, results of the mining; and
generating a request for documentation as a function of the indication.

25. The instructions of claim 24 wherein mining comprises inferring information.

26. The instructions of claim 24 wherein mining comprises mining as a function of the clinical guideline.

27. The instructions of claim 24 wherein determining comprises identifying an element of the patient record suggesting adherence and assigning a likelihood of adherence as a function of the element.

28. The instructions of claim 24 wherein generating comprises generating a notice of the inadequate probability and the associated indication in the patient record.

29. The instructions of claim 28 wherein generating the notice comprises requesting additional documentation for the patient record.

30. In a computer readable storage medium having stored therein data representing instructions executable by a programmed processor for adherence to a clinical guideline, the storage medium comprising instructions for:
mining a previous patient record including unstructured data;
receiving first data input at a time of treatment of a patient;
determining a first probability of a particular disease as a function of the first data and results of the mining, the particular disease corresponding to the clinical guideline;
suggesting additional information to be obtained which may change the first probability;
receiving second data associated with the additional information at the time of the treatment of the patient; and
determining a second probability as a function of the second data.

31. The instructions of claim 30 wherein the clinical guideline is for a clinical trial, further comprising:
outputting clinical trial information as a function of the second probability.

32. The instructions of claim 30 further comprising:
determining a third probability of another disease as a function of the first data and the results of the mining; and
wherein suggesting comprises suggesting the additional information to distinguish between the particular and other diseases.

33. The instructions of claim 30 further comprising:
initiating a workflow if the second probability is above a threshold.

34. The instructions of claim 30 wherein suggesting additional information comprises suggesting a test order, a recommended action, a request for patient information or combinations thereof.
